(19) United States
(12) Patent Application Publication
(10) Pub. No.: US 2024/0289868 A1
(43) Pub. Date: Aug. 29, 2024

(54) SYSTEMS AND METHODS FOR ENHANCING ONLINE SHOPPING EXPERIENCE

(71) Applicant: Locker 2.0, Inc., Glendale, CA (US)

(72) Inventors: Kristine Elizabeth Locker, Glendale, CA (US); Taylor Michel, Ocala, FL (US)

(21) Appl. No.: 18/583,702

(22) Filed: Feb. 21, 2024

Related U.S. Application Data
(60) Provisional application No. 63/448,945, filed on Feb. 28, 2023.

(51) Int. Cl. G06Q 30/0601

(52) U.S. Cl. CPC G06Q 30/0641

(57) ABSTRACT

A system includes: a processor; and memory including instructions that, when executed by the processor, cause the processor to: receive a selection of a product image stored in a collection of product images for inclusion in a collage; identify a link to a product webpage associated with the product image; generate code for the collage based on at least the product image and the link; and transmit the code for the collage to be displayed on a display device of a user. The collage enables the user to navigate to the product webpage based on the link.

### CROSS-REFERENCE TO RELATED APPLICATION

The present application claims priority to and the benefit of U.S. Provisional Application No. 63/448,945, filed on Feb. 28, 2023, entitled “SYSTEMS AND METHODS FOR ENHANCING ONLINE SHOPPING EXPERIENCE”, the entire disclosure of which is incorporated by reference herein.

### BACKGROUND

### 1. Field

Aspects of embodiments of the present disclosure relate to systems and methods for enhancing online shopping, and more particularly, to systems and methods for managing a user's collection of product webpages.

### 2. Description of Related Art

With the development of the Internet, consumers are enabled to browse websites of various merchants to purchase products that are offered for sale on the websites. In this case, consumers may browse various webpages of the websites using a browser or an application of a user device, such as a personal computer, a tablet, or a smart phone, and may purchase desired products from product webpages of the websites.

The above information disclosed in this Background section is for enhancement of understanding of the background of the present disclosure, and therefore, it may contain information that does not constitute prior art.

### SUMMARY

Recently, an online platform has been developed to enable users to save various products (e.g., product images and/or product webpages) from the websites of various merchants in an online collection for later retrieval. In this case, users may share the product webpages associated with the products with other users, and/or may revisit the product webpages saved in the online collection as needed or desired, for example, such as when ready to purchase the product being offered from the product webpage.

Aspects of one or more embodiments of the present disclosure are directed to systems and methods for managing a user's collection of product webpages.

According to one or more embodiments of the present disclosure, a collage creation tool may be provided to enable users to create collages of product pages they have saved to their collections maintained by the system.

According to one or more embodiments of the present disclosure, a URL processing feature may be provided to ensure that information associated with the product pages saved to the collections and/or the collages include updates made to source websites from which the product pages are saved.

According to one or more embodiments of the present disclosure, user data collected and/or maintained by the system may be leveraged to provide unique brand offers to the users based on their activities and the products saved in their collections.

According to one or more embodiments of the present disclosure a system includes: a processor; and memory including instructions that, when executed by the processor, cause the processor to: receive a selection of a product image stored in a collection of product images for inclusion in a collage; identify a link to a product webpage associated with the product image; generate code for the collage based on at least the product image and the link; and transmit the code for the collage to be displayed on a display device of a user. The collage is configured to enable the user to navigate to the product webpage based on the link.

In an embodiment, the instructions may further cause the processor to identify a first data structure for the product image stored in the collection, and the link may be identified from the first data structure.

In an embodiment, the instructions may further cause the processor to generate a second data structure for the product image in the collage based on at least the link identified from the first data structure, and the first and second data structures may be independently maintained from each other.

In an embodiment, the instructions may further cause the processor to generate a third data structure for the collage based on at least the second data structure, and the third data structure may reference the second data structure.

In an embodiment, the code may be generated based on at least the second and third data structures.

In an embodiment, to generate the second data structure, the instructions may further cause the processor to: identify a status of the link to the product webpage associated with the product image; and input the status into a status component of the second data structure.

In an embodiment, the status may correspond to at least one of a validity of the link, a price of a product corresponding to the product image from the product webpage, or an availability of the product from the product webpage.

In an embodiment, the instructions may further cause the one or more processor to: determine that the link is no longer valid; and deactivate the link for the product image in the collage.

In an embodiment, to determine that the link is no longer valid, the instructions may further cause the one or more processors to: identify a link entry for the product webpage in a table; determine that the link entry is slated for an update; connect to the product webpage; and determine that a current status of the product webpage is inactive.

In an embodiment, the product image stored in the collection of product images may be maintained through a first data structure configured to store at least link information for the link to the product webpage associated with the product image; in response to the product image being selected for inclusion in the collage, a second data structure may be generated based on the first data structure; and when the product image is removed from the collection of product images, the first data structure for the collection may be deleted, and the second data structure may be maintained for the collage.

According to one or more embodiments of the present disclosure, a system includes: a processor; and memory including instructions that, when executed by the processor, cause the processor to: receive a selection of a product image in a collection of product images for inclusion in a collage; identify a first data structure associated with the product image in the collection; generate a second data structure for the product image based on the first data structure; generate the collage based on at least the second data structure; and cause a display of the collage on a display device of a user.

In an embodiment, to generate the second data structure, the instructions may further cause the processor to: identify a link to a product webpage associated with the selected product image from the first data structure; identify a status of the link through a lookup of a table; and input the status into a status component of the second data structure.

In an embodiment, the status may correspond to at least one of a validity of the link, a price of a product corresponding to the product image from the product webpage, or an availability of the product from the product webpage.

In an embodiment, the instructions may further cause the processor to: identify a change in the status of the link; and update each of the first and second data structures based on the change in the status.

In an embodiment, to determine the change in the status of the link, the instructions may further cause the processor to: identify a previously stored status of the link in the table; connect to the product webpage associated with the selected product image; identify a current status from the product webpage; and compare the current status with the previously stored status to determine the change in status.

According to one or more embodiments of the present disclosure, a method includes: receiving, by a processor, a selection of a product image in a collection of product images for inclusion in a collage; identifying, by the processor, a first data structure associated with the product image in the collection; generating, by the processor, a second data structure for the product image based on the first data structure; generating, by the processor, the collage based on at least the second data structure; and causing, by the processor, a display of the collage on a display device of a user.

In an embodiment, to generate the second data structure, the method may further include: identifying, by the processor, a link to a product webpage associated with the selected product image from the first data structure; identifying, by the processor, a status of the link through a lookup of a table; and inputting, by the processor, the status into a status component of the second data structure.

In an embodiment, the status may correspond to at least one of a validity of the link, a price of a product corresponding to the product image from the product webpage, or an availability of the product from the product webpage.

In an embodiment, the method may further include: identifying, by the processor, a change in the status of the link; and updating, by the processor, each of the first and second data structures based on the change in the status.

In an embodiment, to determine the change in the status of the link, the method may further include: identifying, by the processor, a previously stored status of the link in the table; connecting, by the processor, to the product webpage associated with the selected product image; identifying, by the processor, a current status from the product webpage; and comparing, by the processor, the current status with the previously stored status to determine the change in status.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 illustrates a block diagram of a product page collection system according to one or more embodiments of the present disclosure.

FIG. 2 illustrates a schematic view of a collage creation interface, according to one or more embodiments of the present disclosure.

FIG. 3 illustrates a schematic view of a product selection interface, according to one or more embodiments of the present disclosure.

FIG. 4 illustrates a schematic view of the collage creation interface including selected products, according to one or more embodiments of the present disclosure.

FIG. 5 illustrates a schematic block diagram of various data structures, according to one or more embodiments of the present disclosure.

FIG. 6A illustrates a flow diagram of a method of creating a collage from a collection of product images using a collage creation tool, according to one or more embodiments of the present disclosure.

FIG. 6B illustrates a flow diagram of a method of generating a second data structure for a product image added to a collage according to one or more embodiments of the present disclosure.

FIG. 7 illustrates a schematic block diagram of various data structures used by a URL processing feature, according to one or more embodiments of the present disclosure.

FIG. 8 illustrates a flow diagram of a method of identifying a change in status of a URL associated with a product image of at least one of a collection or a collage, according to one or more embodiments of the present disclosure.

FIG. 9 is a schematic view of a collage view interface 900, according to one or more embodiments of the present disclosure.

FIG. 10 is a schematic view of a selected collage interface 1000, according to one or more embodiments of the present disclosure.

FIG. 11 is a schematic view of a quick edit interface 1100, according to one or more embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

One of the challenges facing online shopping platforms and systems is the difficulty that users often have in visualizing products in real-world scenarios, such as outfits or room furnishings. This can make it difficult for users to make informed purchasing decisions, and can lead to frustration and dissatisfaction with the online shopping experience.

According to one or more embodiments of the present disclosure, a collage creation tool may be provided to enable users to create collages of products (e.g., product images and their associated product webpages) that they have saved to their collections. The collage creation tool may provide users with a visually appealing way to organize products into an inspiration board that is carefully crafted and customized to match the style and/or esthetics that the users are looking for, and may allow other users to quickly access the products (e.g., via their associated product webpage URLS or other links) within the generated collages. In other words, the collages provide a visual representation of products handpicked and paired by the users, making it easier for the users to imagine how the products will look and function in their own lives. The collage creation tool may allow users to select products from their collections, and arrange or customize them as they see fit. The collages may be saved, shared, and viewed by other users, providing a new way for users to engage with products and with each other.

According to one or more embodiments of the present disclosure, a collage may be generated from product images scraped from various 3^{rd} party sources (e.g., 3^{rd} party websites), which may be maintained by 3^{rd} party content providers (e.g., merchants and the like), and thus, subject to be changed at any time without advance notice. In this case, the product webpages associated with the product images may become broken or unavailable, such that the link associated with the product image used to generate the collage may become broken or unavailable. Accordingly, user experience may be adversely affected, for example, when clicking on a broken or unavailable link associated with a product image in a generated collage.

According to one or more embodiments of the present disclosure, advance web scraping techniques and methods may be utilized to identify those products having broken or unavailable (e.g., inactive) links in a collection and/or a collage, such that the users may be prevented from clicking or otherwise selecting an inactive link in a collection or a collage. Thus, user experience may be improved.

According to one or more embodiments of the present disclosure, in addition to the active/inactive status of the link in a corresponding collection or collage, additional information regarding the product in the collection or collage, such as the product's price, price changes, stock availability, and/or the like, may be scraped from the 3^{rd} party sources and displayed along with the collage and the various products contained in the collage. As such, rather than requiring the users to navigate through the cumbersome process of individually inspecting multiple merchant websites for potential changes in a product's price or availability, the user may simply view the collage and the products contained therein to determine such additional information. The system enhances user experience by automatically gathering and displaying real-time updates on product pricing and availability from 3^{rd} party sources, thereby eliminating the need for users to manually check each individual merchant's website. The system's automatic update feature ensures that users stay informed without the hassle of constant manual verifications, which may significantly improve overall efficiency and convenience.

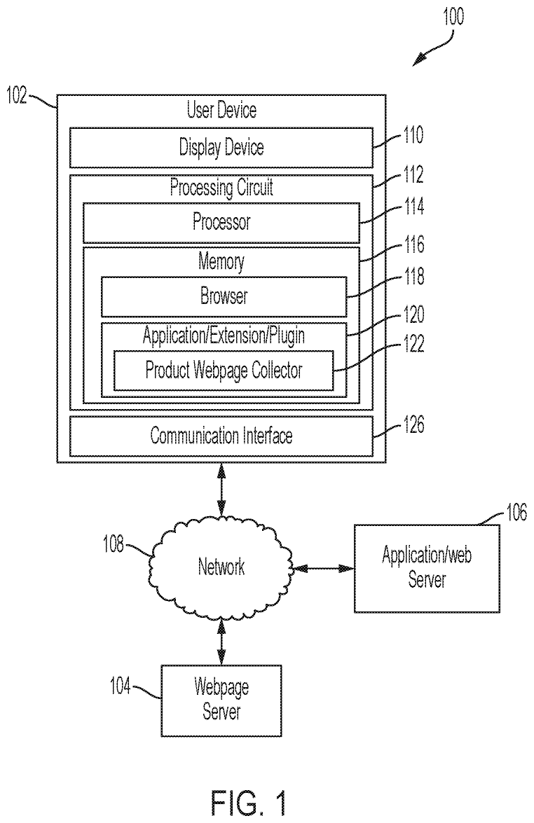

FIG. 1 illustrates a block diagram of a product page collection system 100 according to one or more embodiments of the present disclosure. In brief overview, the product page collection system 100 may identify product images and their associated product webpages, and may save the product images and their associated product webpages in a collection, for example, like that of the recommendation system 100 described in U.S. patent application Ser. No. 17/443,747, the entirety of which is incorporated by reference herein.

In more detail, referring to FIG. 1, the product page collection system 100 may include a user device 102 that is communicably connected to a webpage server 104 and an application/web server 106 over a communications network 108. A browser 118 of the user device 102 may communicate with the webpage server 104 over the communications network 108 to request a webpage to be displayed on a display device 110 connected to or included in the user device 102. The browser 118 may include any suitable internet browser, for example, such as Chrome®, Internet Explorer®, Firefox®, Safari®, Opera®, and the like. However, the present disclosure is not limited thereto, and in other embodiments, the user device 102 may include any suitable program, application, widget, user interface, and/or the like to enable the user device 102 to access the webpage server 104 to request content (e.g., webpages) to be displayed on the display device 110 associated with (e.g., connected to or included in) the user device 102.

The user device 102 may include a processing circuit 112 having a processor 114 and memory 116, and a communication interface 126 for communicating with the webpage server 104 and/or the application/web server 106 over the communications network 108. In various embodiments, the processor 114 may include a general-purpose processor, an Application Specific Integrated Circuit (ASIC), one or more Field Programmable Gate Arrays (FPGAs), a Digital Signal Processor (DSP), any other suitable electronic processing components, or combinations thereof. The memory 116 may include tangible, non-transient, volatile memory, or non-volatile memory, for example, such as Random Access Memory (RAM), Read-Only Memory (ROM), Non-volatile RAM (NVRAM), Flash Memory, hard disk storage, any other suitable electronic storage medium, or combinations thereof. The memory 116 stores instructions (e.g., data, computer code, and/or programming logic) that, when executed by the processor 114, controls the operations of the user device 102. Accordingly, the memory 116 includes database components, object code components, script components, and/or any other type of information structure for supporting the various activities and information structures described herein.

As shown in FIG. 1, according to one or more embodiments of the present disclosure, the memory 116 includes the browser 118 and an application/extension/plugin 120. In some embodiments, the application/extension/plugin 120 may work in tandem with the browser, or may be a separate application from that of the browser 118. The browser 118 communicates with the webpage server 104 over the communications network 108 (e.g., via the communication interface 126) to request one or more webpages for display on the display device 110. For example, the browser 118 may transmit (e.g., via a URL, an IP address, and/or the like) a request (e.g., HTTP GET) to the webpage server 104 for a requested webpage, and may receive a response (e.g., HTTP POST) from the webpage server 104 including code (e.g., HTML, XML, and/or the like) corresponding to the requested webpage. The browser 118 interprets the code, retrieves any images according to the code (e.g., according to URLs or other suitable links to the images contained in the code), and displays the requested webpage including the retrieved images on the display device 110 according to the code.

The application/extension/plugin 120, which may be installed (e.g., loaded or downloaded) into the memory 116, may include a product webpage collector 122. The product webpage collector 122 may identify a product webpage from among the webpages of a website, and may enable a user to select and save the product webpage (e.g., along with a product image associated with the product webpage) in a collection maintained by the application/web server 106 for the user. For example, when the user (e.g., a first user or a first consumer) selects a save function appended to a product image of a webpage, the product webpage collector 122 may be invoked to communicate and exchange data with the application/web server 106 over the communications network 108, for example, such as to save a product webpage linked to the selected product image, and/or to provide a recommendation of the product webpage linked to the selected product image to another user (e.g., to a second user or a second consumer). In other words, the product webpage collector 122 may request user information and data from the application/web server 108, and may provide user inputs to the application/web server 108.

The webpage server 104 may host webpages that are managed by third-party sources (e.g., a third-party content provider, such as merchants and the like). According to one or more embodiments of the present disclosure, the webpage server 104 may host webpages that are managed by various different third party sources, for example, such as a web host, or may be a webpage server located at a data center of a particular third party content provider to host webpages of the particular third party content provider. The webpage server 104 may host and serve various webpages that are managed by one or more third party sources, and may provide the webpages to the browser 118 over the communications network 108 upon request (e.g., HTTP GET via a URL or other suitable link).

The application/web server 106 may include one or more application servers, web servers, data stores, and/or the like. The application/web server 106 may include one or more processing circuits having one or more processors and memory. The one or more processors may include a general-purpose processor, an ASIC, one or more FPGAs, a DSP, any other suitable electronic processing components, or combinations thereof. The memory may include tangible, non-transient, volatile memory, or non-volatile memory, for example, such as RAM, ROM, NVRAM, Flash Memory, hard disk storage, any other suitable electronic storage medium, or combinations thereof. The memory stores instructions (e.g., data, computer code, and/or programming logic) that, when executed by the one or more processors, controls the operations of the application/web server 106. Accordingly, the memory includes database components, object code components, script components, and/or any other type of information structure for supporting the various activities and information structures described herein.

According to one or more embodiments of the present disclosure, the application/web server 106 may host an application page, a webpage, a dashboard, a user interface, and/or the like that may be accessible via the browser 118 or a separate application installed on the user device 102 to enable the user to manage one or more collections stored in the application/web server 106, and/or interactions with other users. For example, the application page, the webpage, the dashboard, the user interface, and/or the like may provide an interface to the user to manage the saved products (e.g., the product images and their product webpage URLs or other suitable link) that have been collected from various websites that the user browses, revisit the various saved product webpages (e.g., via their URL or other suitable link), manage the collections (e.g., categories or containers of saved product images and their product webpage URLS or other suitable links), review recommendations, communicate with other users, manage friends (e.g., potential recommendees), and/or the like. According to one or more embodiments of the present disclosure, the application/web server 106 may manage and store various user information and data, and may provide the user information and data to the application/extension/plugin 120.

The communication interface 126 may be or include wired or wireless communications interfaces (e.g., jacks, antennas, transmitters, receivers, transceivers, wire terminals, and/or the like) for conducting data communications with the webpage server 104 and/or the application/web server 106. In various embodiments, communications via the communication interface 126 can be direct (e.g., local wired or wireless communications) or via the communications network 108 (e.g., a WAN, the Internet, a cellular network, and/or the like). For example, the communication interface 126 may include a Wi-Fi transceiver for communicating via a wireless communications network. In another example, the communication interface 126 may include an Ethernet card and port for sending and receiving data via an Ethernet-based communications link or network. In another example, the communication interface 126 may include cellular or mobile phone communications transceivers. In various embodiments, the communication interface 126 may support various suitable protocols (e.g., TCP/IP, User Datagram Protocol UDP, Hypertext Transfer Protocol HTTP, Internet Message Access Protocol IMAP, Simple Mail Transfer Protocol SMTP, and/or the like) and/or data communication interfaces (e.g., Application Program Interface API, Web Services, and/or the like) for facilitating data communications with the webpage server 104, the application/web server 106, and/or the like.

The communications network 108 may include any suitable wired or wireless network (e.g., a Local Area Network (LAN), a Wide Area Network (WAN), cellular communications network, and/or the like). For example, the network 108 may include Frequency Division Multiple Access (FDMA), Time Division Multiple Access (TDMA), Code Division Multiple Access (CDMA) (e.g., Evolution-Data Optimized (EVDO)), Universal Mobile Telecommunications Systems (UMTS) (e.g., Time Division Synchronous CDMA (TD-SCDMA or TDS)), Wideband Code Division Multiple Access (WCDMA), Long Term Evolution (LTE), evolved Multimedia Broadcast Multicast Services (eMBMS), High-Speed Downlink Packet Access (HSDPA), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, Wi-Fi, any suitable wired network, combinations thereof, and/or the like.

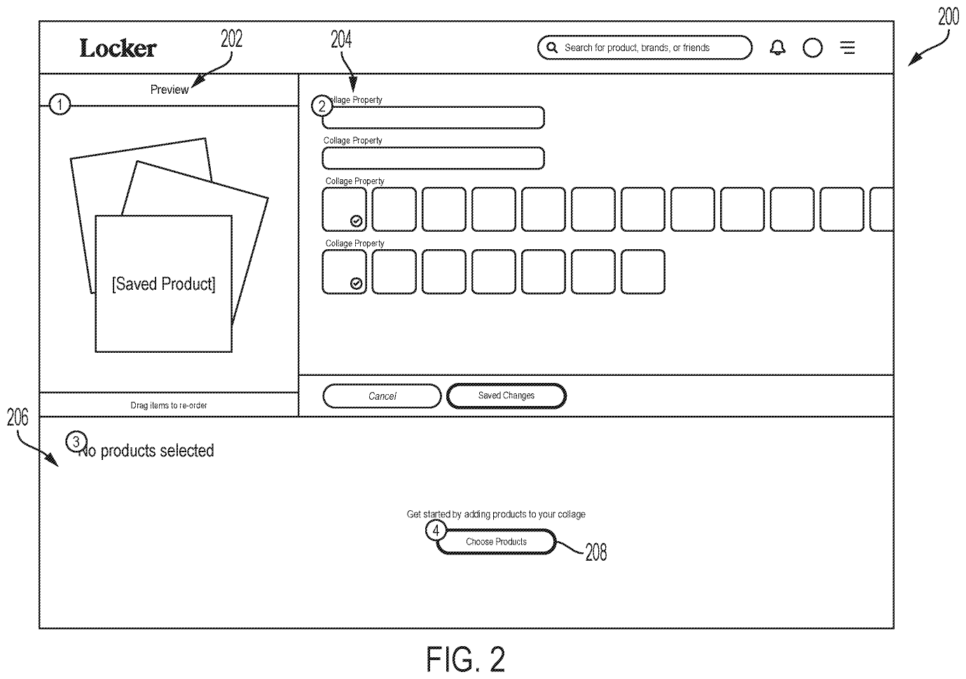

Hereinafter, a collage creation tool provided by the application/web server 106 to enable a user to generate a collage from a collection of saved product images (and their product webpage URLs or links) will first be described in more detail with reference to FIGS. 2 through 4.

According to one or more embodiments of the present disclosure, the application/web server 106 may provide the collage creation tool to enable users to create collages of products they have saved to their collections. The collages provide a visually appealing representation of the products handpicked and paired by the users, making it easier for the users to imagine how the products will look and function in their own lives. The collage creation tool may allow users to select products from their collections, and arrange or customize them as they see fit in a collage. The collages may be saved, shared, and viewed by other users, providing a new way for users to engage with products and with each other. The collages may also allow the user (and other users that the collages are shared with) to quickly access the products (e.g., via their associated product webpage URLs or other suitable links) within the generated collage.

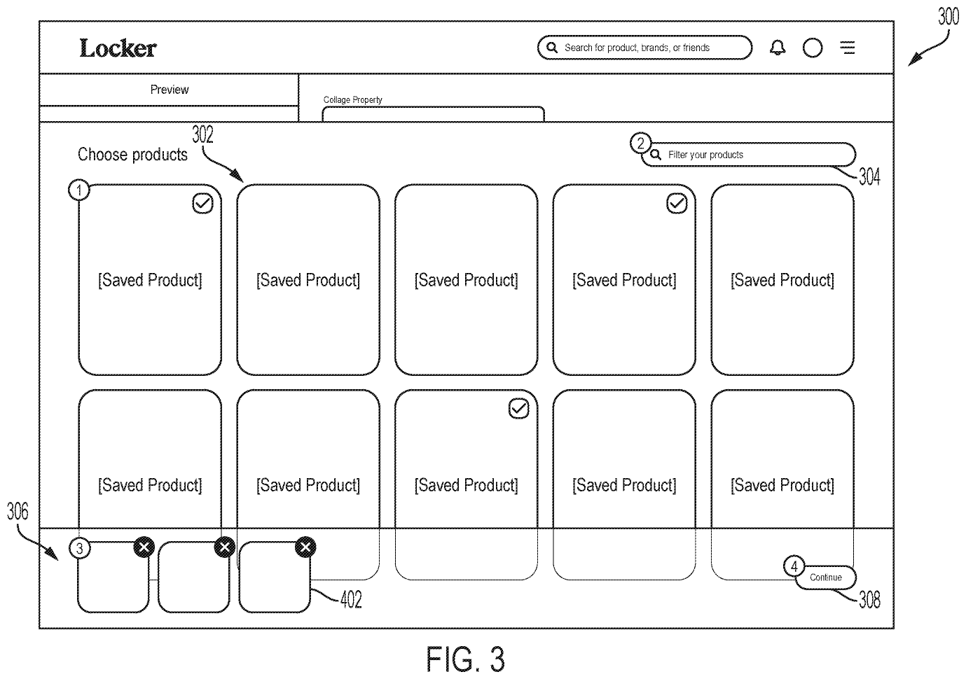

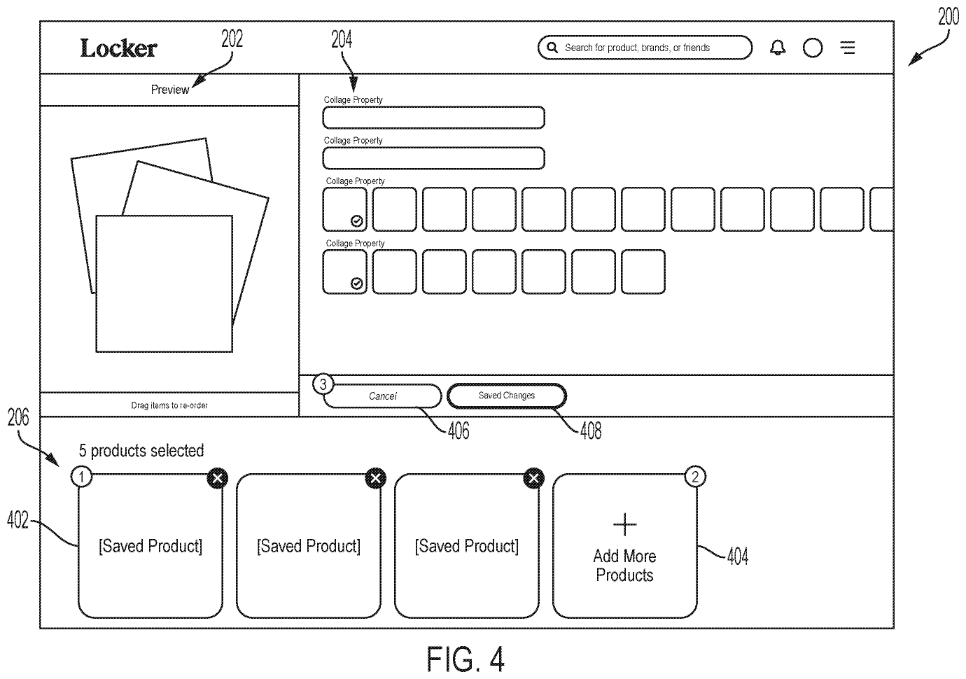

FIG. 2 illustrates a schematic view of a collage creation interface 200, according to one or more embodiments of the present disclosure. FIG. 3 illustrates a schematic view of a product selection interface 300, according to one or more embodiments of the present disclosure. FIG. 4 illustrates a schematic view of the collage creation interface 200 including selected products 402, according to one or more embodiments of the present disclosure.

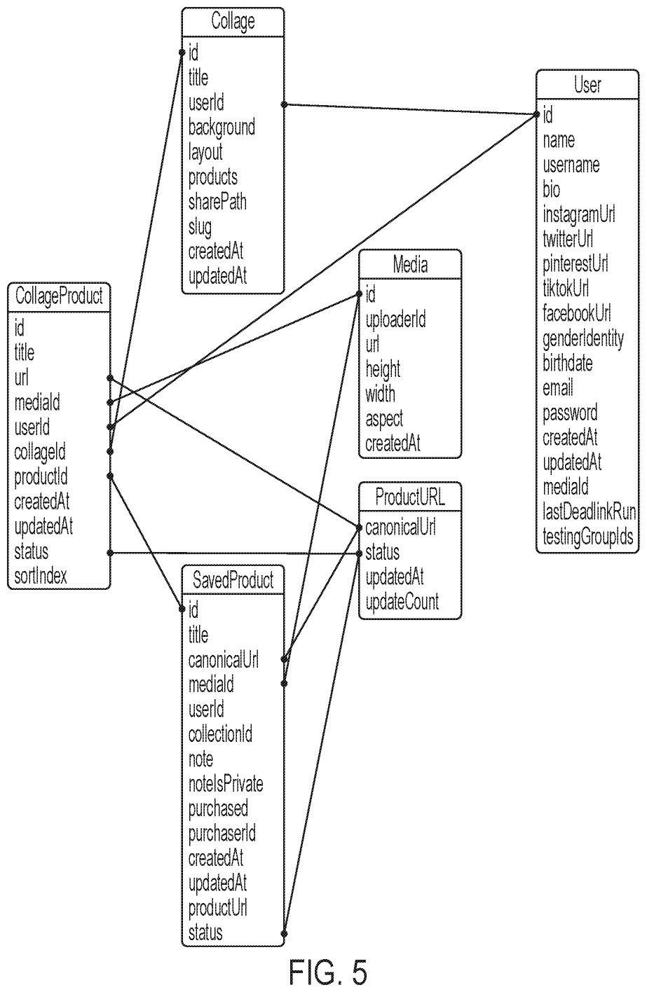

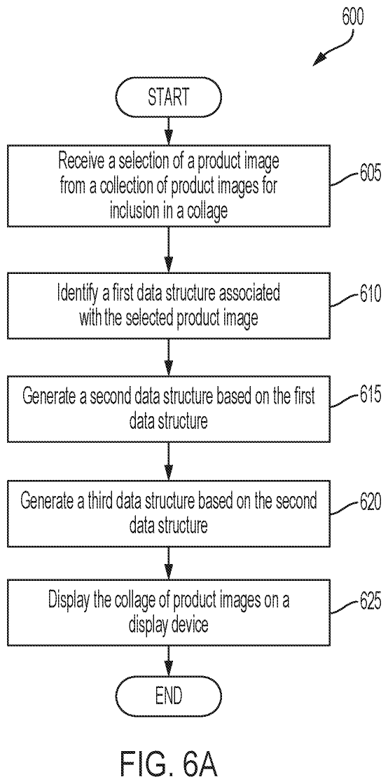

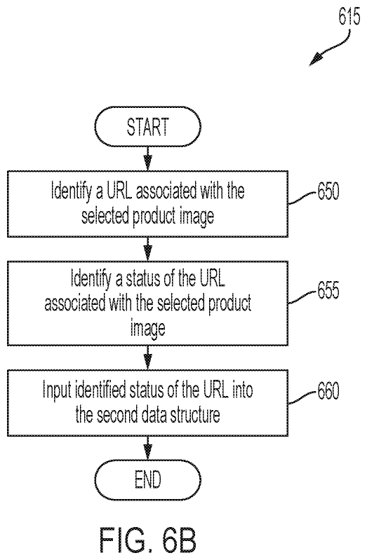

Referring to FIG. 2, the collage creation interface 200 may be provided to allow users to select products (e.g., product images) from a user's collection, and arrange them how they choose to create a unique collage. For example, each product (e.g., the product image and corresponding product webpage URL or other link) saved in a user's collection may have associated with it, a first data structure (e.g., SavedProduct), which will be described in more detail below with reference to FIGS. 5 and 6A-6B. The collage creation interface 200 may provide a drag-and-drop interface, and may be built, for example, using HTML Canvas. The collage creation interface 200 provides users with the ability to zoom in and out, adjust the size and position of the products (e.g., their product images) within the collage, and add images and text. For example, according to one or more embodiments of the present disclosure, the collage creation interface 200 may include a live preview panel 202, a property panel 204, a selected products panel 206, and a choose products button 208.

The live preview panel 202 may be a panel that allows the user to drag and drop the selected products (e.g., the selected product images) from his/her collection into unique arrangements of a collage. Users have the flexibility to swap, layer, and reposition the product images according to their preferences. Additionally, users can customize the collage by adding text, background images, and other styling elements, allowing them to personalize the collage to their liking. All these modifications can be visualized in the live preview panel 202.

The property panel 204 may allow the user to adjust all properties related to the collage, and anything selected in the live preview panel 202. The user may change base properties on the collage, such as the title or background, and may also drill deeper into the settings of individual collage items (e.g., individual product images) to do things like remove the background of an image, change the color of a text block, or simply fine-tune the background.

The selected products panel 206 serves as a window that enables users to view, add, or remove all products currently chosen for inclusion in the collage. The choose products button 208, when selected, presents the user with a view for selecting the products (e.g., the product images) from their existing collections. The selected products panel 206 and the choose products button 208 will be described in more detail below with reference to FIGS. 3 and 4.

Referring to FIG. 3, the collage creation tool may allow users to select products (e.g., product images) that are stored in their collections to include in the collage. For example, in response to selecting the choose products button 208 from the collage creation interface 200 illustrated in FIG. 2, the user may be presented with the product selection interface 300 illustrated in FIG. 3. The product selection interface 300 may include an existing products panel 302, a products search bar 304, a currently selected panel 306, and a continue button 308.

The existing products panel 302 may be a panel that allows the user to select products (e.g., product images) to be used in their collage. For example, when a user selects a product for inclusion for their collage, the system may generate a second data structure (e.g., CollageProduct) for the selected product, which will be described in more detail below with respect to FIGS. 5 and 6. All products from any collection associated with the user's account may be viewed in the existing products panel 302. The products search bar 304 enables the user to search through their products using keywords found in the product title, collection title, and the like.

The currently selected panel 306 presents the user with all of the products 402 that have been currently selected for inclusion in the collage. Here, selecting the “X” button on any of the selected products 402 will remove it from the selection. The continue button 308, when selected, finalizes the selected products 402 for inclusion in the collage, dismisses the currently selected panel 306, and directs the user back to the collage creation interface 200, which now includes the selected products 402, as illustrated in FIG. 4.

Referring to FIG. 4, the selected products 402 may be included in the selected products panel 206 of the collage creation interface 200. From the selected products panel 206, the user may quickly view and/or remove the products 402 that they have added to the collage. According to one or more embodiments of the present disclosure, when the user adds one or more products to the selected products panel 206 (e.g., via the product page selection interface 300), the selected products panel 206 may include the selected products 402, and may further include an add more products button 404. The add more products button 404 may allow the user to quickly return to the product page selection interface 300 to select additional products from the existing products panel 302 for inclusion in the collage.

Still referring to FIG. 4, according to one or more embodiments of the present disclosure, the collage creation interface 200 may further include a cancel button 406 and a save button 408. The cancel button 406 may allow the user to cancel all of the pending changes to the collage, and the save button 408 may allow the user to save the pending changes, for example, such as when the user is done creating and/or editing their collage. Further, the save button 408 may also finalize the user's collage, thereby causing a third data structure (e.g., Collage) for the collage to be generated based on the second data structure (e.g., CollageProduct) generated for each of the products included in the collage, which will be described in more detail below.

FIG. 5 illustrates a schematic block diagram of various data structures, according to one or more embodiments of the present disclosure.

Referring to FIG. 5, as described above, when a product (e.g., a product image and corresponding product webpage URL or other link) is added to a user's collection, a first data structure (e.g., SavedProduct) may be generated for the added product to store or otherwise maintain a link between the product image and the product webpage of the product obtained from a 3^{rd} party source (e.g., a merchant website). The user's collection, as described above, may serve as a repository for the products (e.g., the product images and their associated product webpage URLs or other links) added thereto by the user, and thus, a corresponding SavedProduct data structure may be generated for each product saved in the user's collection. For example, the SavedProduct data structure may have a few components, including but not limited to, Id, UserId, and CanonicalURL. The Id component may correspond to a unique id for the product associated with the SavedProduct data structure. The UserId component corresponds to a unique identifier of the user associated with the collection having the product added therein.

The CanonicalURL component of the SavedProduct data structure is indicative of a uniform resource locator (“URL”) or other suitable link of the product webpage from which the product image was obtained. The CanonicalURL component may store the primary and authoritative address for the 3^{rd} party product web page from which the product image was obtained, such that the user may revisit the product web page, for example, by clicking on the product image in the collection and/or the collage.

In some embodiments, upon creation of the collage, any products (e.g., SavedProduct) added to the collage from the collection may have an associated second data structure (e.g., CollageProduct) generated for it. The CollageProduct data structure holds key information about the product to be served at the time of viewing the collage. For example, the CollageProduct data structure may be generated based on the corresponding SavedProduct data structure for each of the added products from the collection. Accordingly, each product included in the collection as well as in the collage may have corresponding first and second data structures generated for it, so that the first and second data structures for each of the products may be independently maintained. As such, when a change is made to a product image in a collection that is also included in a collage, the product image (and its associated URL or other link) in the collage may be maintained via the corresponding second data structure (e.g., CollageProduct) thereof. Similarly, when a change is made to the product image in the collage, the corresponding first data structure (e.g., SavedProduct) of the product image for the collection may be maintained. For example, when a user deletes a product image from his/her collection, the associated first data structure (e.g., SavedProduct) for the product image may be deleted, but the associated second data structure (e.g., CollageProduct) may be maintained, so that the collage including the product image is unaffected by the deletion of the product image (and its corresponding SavedProduct data structure) from the collection.

For example, the CollageProduct data structure may have a few components, including but not limited to, UserId, ProductId, Title, URL, MediaId, Status, and CollageId. The UserId component of the CollageProduct data structure corresponds to a unique identifier of the user having the product selected for inclusion in the collage. According to one or more embodiments of the present disclosure, the UserId component of the CollageProduct data structure may be linked to the Id component of a User data structure generated for the user, which will be described in more detail below. The ProductId component of the CollageProduct data structure may correspond to the Id component of the associated product from the SavedProduct data structure thereof. In some embodiments, on deletion of a corresponding SavedProduct data structure, the ProductId component of the associated CollageProduct data structure may be set to ‘null’, but the associated CollageProduct data structure may be otherwise left untouched. The Title component of the CollageProduct data structure may correspond to the title component of the corresponding SavedProduct data structure.

The URL component of the CollageProduct data structure may correspond to the original product webpage link, and may be obtained from the Canonical URL component of the corresponding first data structure (e.g., SavedProduct) when the CollageProduct data structure is created. However, the present disclosure is not limited thereto, and the URL component of the CollageProduct data structure may be obtained from a fourth data structure (e.g., ProductURL), which will be described in more detail below. The MediaId component of the CollageProduct data structure may correspond to the original image associated with the product for reference. According to one or more embodiments of the present disclosure, on deletion of a CollageProduct data structure, the associated SavedProduct and Media data structures may not be affected. The Status component of the CollageProduct data structure, which will be described in more detail below, may be a status that is synced with the product's product webpage URL or other suitable link, to check if it is still a valid link and/or to ascertain other useful information (e.g., price, stock availability, price change, and/or the like) regarding the product from the product webpage to be provided to the user.

The CollageId component of the CollageProduct data structure may be linked to an Id component of a generated third data structure (e.g., Collage) upon creation of the collage, so that each of the CollageProduct data structures for a created collage may be linked to or otherwise associated with the created collage. For example, when the collage (and thus, the associated third data structure (Collage)) is deleted, all linked or otherwise associated CollageProduct data structures thereof may also be deleted. However, the SavedProduct data structures corresponding to the CollageProduct data structures of the collage may be maintained so that the corresponding product may be maintained in the user's collection, even when the collage and its corresponding CollageProduct data structures are deleted. In some embodiments, the Collage data structure may have a few components, including, but not limited to, Title, Background, Layout, SharePath, Products, and UserId.

The Title component of the Collage data structure may correspond to the title of the collage. The Background component may correspond to a selected background image, such as a gradient or a solid color. The Layout component may be a json document with all user configured layout information. For example, the Layout component may contain information about the position, rotation, and sizing information for the product images, but is not limited thereto. The Layout component may also contain information about other non-product images and text added to the collage. The SharePath component may be a link that is generated that is unique to that collage to ensure that the collage is always available as long as it exists, for example, when sharing the collage. The Products component may correspond to a relational collection of the product images (e.g., the CollageProduct data structures) associated with the collage. The UserId component corresponds to the id of the user that created the collage.

According to one or more embodiments, the User data structure may have a few components, including but not limited to, Id, Name, and Birthdate. The Id component may correspond to the id of the user. The Name component may correspond to the name of the user. The Birthdate component may correspond the date of birth of the user.

According to one or more embodiments, the Media data structure may have a few components, including but not limited to, URL, Height, and Width. The URL component of the Media data structure points to the actual image of the product stored in the Cloud. The Height and Width components may correspond to the height and width dimensions of the actual image of the product stored in the Cloud.

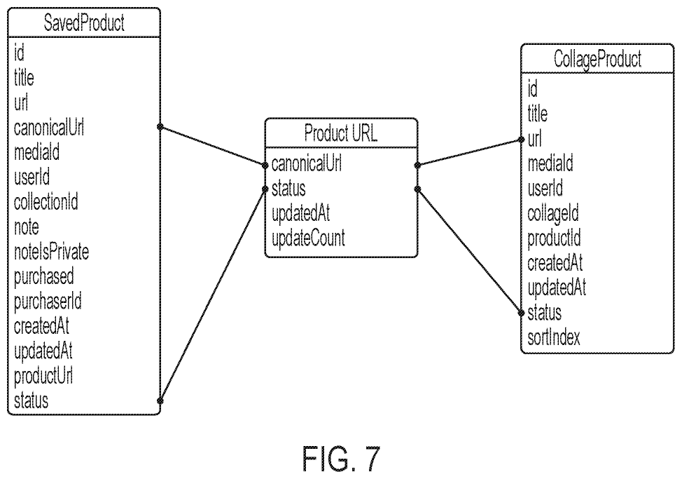

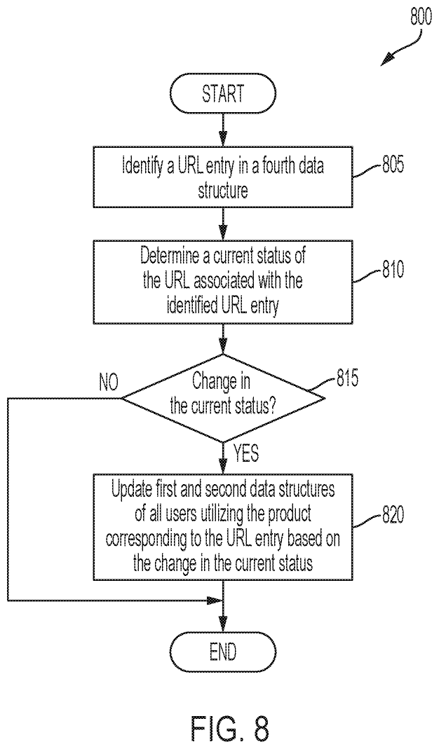

According to one or more embodiments of the present disclosure, the fourth data structure (e.g., ProductURL), which will be described in more detail below with reference to FIGS. 7 and 8, may be an authoritative source from which the Status component of the first and second data structures (e.g., see FIG. 5) may be obtained. In some embodiments, there may be an entry in the ProductURL data structure for any product added to a collection or a collage of any user, but there may be only one entry for the same product webpage URL in the ProductURL data structure no matter how many users have added the product (with the same product web page URL) to their collections or collages. The ProductURL data structure may be used to periodically check the Status of a product webpage URL of a product that is in a collection or a collage, and if the status has changed since last checked, may update the first and second data structures for all users having the product (with the same product web page URL) in a collection or a collage.

For example, the ProductURL data structure may have a few components, including but not limited to, CanonicalURL, Status, UpdatedAt, and CountAt. The CanonicalURL component is indicative of the canonical URL linked to the product webpage from which the product image was obtained. The CanonicalURL component may store the primary and authoritative address for the product web page. The Status component may correspond to information regarding whether or not the URL of the CanonicalURL component is active or inactive. The Status may further correspond to information pertaining to the stock, pricing, and/or availability of the product for a given CanonicalURL. The UpdatedAt component may correspond to the last time that the URL of the CanonicalURL component was checked by a URL processing feature, and the UpdateCount component may correspond to the number of times the URL has been checked by the URL processing feature. The ProductURL data structure and the URL processing feature will be described in more detail below with reference to FIGS. 7 and 8.

FIG. 6A illustrates a flow diagram of a method of creating a collage from a collection of product images using a collage creation tool, according to one or more embodiments of the present disclosure. FIG. 6B illustrates a flow diagram of a method of generating a second data structure for a product image added to a collage according to one or more embodiments of the present disclosure.

For example, the method 600 shown in FIGS. 6A-6B may be performed by the application/web server 106 (e.g., a processor thereof) described above. However, the present disclosure is not limited thereto, and the operations shown in the method 600 may be performed by any suitable one of the components and elements or any suitable combination of the components and elements of those of one or more example embodiments described above. Further, the present disclosure is not limited to the sequence or number of the operations of the method 600 shown in FIGS. 6A-6B, and can be altered into any desired sequence or number of operations as recognized by a person having ordinary skill in the art. For example, in some embodiments, the order may vary, or the method 600 may include fewer or additional operations.

First, referring to FIGS. 5 and 6A, the method 600 may start, and a selection of a product image from a collection of product images for inclusion in a collage may be received at block 605. For example, the application/web server 106 (e.g., a processor thereof) may receive the selection of the product image from the user of the user device 102 interacting with the collage creation interface 200, as described above. For example, in response to selecting the choose products button 208 from the collage creation interface 200 illustrated in FIG. 2, the user may access the product page selection interface 300 illustrated in FIG. 3 for selecting one or more products (e.g., product images) from the user's collection to be included in the collage.

At block 610, a first data structure (e.g., SavedProduct) associated with the selected product image may be identified. For example, the application/web server 106 (e.g., the processor thereof) may identify a corresponding SavedProduct data structure (e.g., the first data structure) for the product image selected from the user's collection. As described above, each product that is stored in the user's collection has an associated SavedProduct data structure (e.g., the first data structure), as shown in FIG. 5.

A second data structure (e.g., CollageProduct) may be generated based on the first data structure at block 615. For example, the application/web server 106 (e.g., the processor thereof) may generate the CollageProduct data structure (e.g., the second data structure) based on the first data structure (e.g., SavedProduct), as every selected product in the user's collection has an associated SavedProduct data structure. Accordingly, the first and second data structures may be independently maintained, such that on deletion of a second data structure (e.g., CollageProduct), the associated first data structure (e.g., SavedProduct) and Media data structure (e.g., see FIG. 5) are not affected. In some embodiments, a Media data structure (e.g., see FIG. 5) that is attached to or otherwise associated with any first data structure (e.g., SavedProduct) or second data structure (e.g., CollageProduct) may not be deleted as long as they exist.

At block 620, a third data structure (e.g., Collage) may be generated based on the second data structure. For example, the application/web server 106 (e.g., the processor thereof) may generate the Collage data structure (e.g., the third data structure) for a generated/saved collage based on one or more second data structures (e.g., the CollageProduct data structures) generated for the products contained in the collage. It should be appreciated by those having ordinary skill in the art that blocks 605 to 615 may be repeated for each product added from the collection to the collage, such that the third data structure generated at block 620 may be generated and linked based on a plurality of second data structures generated for a plurality of products added from the collection to the collage.

In some embodiments, upon update of the collage, a combination of new SavedProduct data structures and existing CollageProduct data structures may be provided. During update, any CollageProduct data structures that have been removed will be removed without affecting the original corresponding SavedProduct data structures. Any newly added products may have a corresponding CollageProduct data structure created and linked. In some embodiments, upon deletion of a Collage data structure, all associated CollageProduct data structures may also be deleted, but the linked SavedProduct and Media data structures may not be affected.

At block 625, the collage of product images is displayed on a display device, and the method 600 may end. For example, the collage of product images may be displayed on the display device 110 of the user device 102 (e.g., based on code provided from the application/web server 106 and based on the corresponding second and third data structures generated for the collage), and the method 600 may end.

Referring to FIGS. 5, 6A, and 6B, in some embodiments, to generate the second data structure at block 615 of the method 600, a URL associated with the selected product image may be identified at block 650. For example, in some embodiments, the URL associated with the selected product image may be identified from the CanonicalURL component of the corresponding first data structure (e.g., SavedProduct) identified at block 610 of the method 600.

A status of the URL associated with the selected product image may be identified at block 655. For example, in some embodiment, the status of the URL may be obtained by a lookup from a fourth data structure (e.g., ProductURL) associated with the product webpage URL of the selected product image. In this case, the most up-to-date information that was last obtained when the status was checked may be provided from the fourth data structure (e.g., ProductURL). However, the present disclosure is not limited thereto, and in some embodiments, the status of the URL may be obtained, for example, from the Status component of the corresponding first data structure (e.g., SavedProduct) identified at block 610 of the method 600.

The identified status of the URL may be input into the second data structure at block 660, the second data structure may be generated, and the method 615 may end, such that the third data structure may be generated based on one or more of the second data structures generated at block 620 of the method 600.

Hereinafter, a URL processing feature provided by the application/web server 106 will be described in more detail below with reference to FIGS. 7 and 8.

FIG. 7 is a schematic block diagram of various data structures used by a URL processing feature, according to one or more embodiments of the present disclosure.

Referring to FIG. 7, in some embodiments, the URL processing feature may automatically process the URLs of the products from various merchant websites that are saved to a collection or a collage. When a user saves a product (e.g., a product image and associated product webpage URL or other link) to a collection or a collage in his/her account, the system automatically and periodically checks the URL to determine if the URL is still active or inactive. In some embodiments, the URL processing feature may further check the URL to determine other useful information, such as if the product is still available, in stock, and at the same price compared to when previously checked. For example, in some embodiments, the system employs advanced web scraping techniques, along with parsing product information provided by the merchant, to extract the relevant information from the products/product web pages, such as pricing and availability. If the URL is no longer active and/or if any of the information has changed, the information may be automatically updated in real or near-real time, and the user may be notified.

According to one or more embodiments of the present disclosure, when a URL is processed in the background, if something changes on the ProductURL data structure associated with the URL, those changes are synced to all related first and second data structures (e.g., SavedProduct and CollageProduct) across the platform. This ensures that products always have the most up-to-date information without having to also query (e.g., lookup) the associated ProductURL data structure entry. For example, the URLs may be processed by first using a HEAD request, followed by a GET request if necessary. URL information may also be obtained through the browser extension's scraping/parsing functionality as users visit merchant websites and product webpages. Before processing a URL, the URL processing feature tests against the UpdatedAt and UpdateCount components of the ProductURL data structure to allow throttling/debouncing URL checks. This keeps the system from processing the same URLs several times over a short period of time. Products marked as invalid/unavailable may be periodically checked in the background to re-validate them as needed, in case they return to the merchant website or become in-stock again.

For example, rather than directly checking a particular product webpage URL for each user that may have the same particular product (e.g., with the same particular product webpage URL) stored in a collection or a collage to obtain the Status information for the particular product webpage URL for each of the users, the application/web server 106 (e.g., the processor thereof) may periodically obtain the status information for the particular product webpage URL once for all of the users, and may store the updated status information in the ProductURL data structure. If there is an update to the status (e.g., the Status component) in the ProductURL data structure for the particular product webpage URL (e.g., as denoted by the CanonicalURL component) since last checked (e.g., based on the UpdatedAt or the UpdatedCount components), the application/web server 106 (e.g., the processor thereof) may update (e.g., may provide, broadcast, or otherwise transmit) the updated status in all of the first and second data structures (e.g., SavedProduct and CollageProduct) corresponding to (e.g., linked with) the particular product (e.g., based on their CanonicalURL components). As such, latency that may be introduced when directly checking for status updates for each individual first or second data structures of each individual user may be minimized or reduced, and processing resources for checking for updated status information may be reduced.

According to one or more embodiments of the present disclosure, upon creation of a SavedProduct data structure or a CollageProduct data structure, an associated entry is created in the ProductURL data structure (which may be in the form of a lookup table) if necessary (e.g., if one does not already exist for the associated product web page URL), and linked to the created SavedProduct data structure or a CollageProduct data structure of the product. The entry in the ProductURL data structure (e.g., table) holds all information pertaining to that specific product web page URL (e.g., active/inactive, availability, pricing, and the like) for all instances of that same URL across all products in the platform. As described above, in the SavedProduct data structure and the CollageProduct data structure, the CanonicalURL component may correspond to the original product webpage link, and the Status component may correspond to the status that is synced with the ProductURL data structure to check if it is still a valid link, as well as to update other useful information (e.g., price, stock availability, and/or the like).

According to one or more embodiments of the present disclosure, by automating the process of tracking valid/invalid links, pricing, and availability information for products across multiple merchant websites, the URL processing feature helps users save time and effort when shopping online. Users no longer need to navigate through multiple websites and manually track pricing updates, allowing them to focus on finding the products they need.

In some embodiments, upon creation of a first data structure (e.g., SavedProduct) or a second data structure (e.g., CollageProduct) of a particular product image added to a collection or a collage, the ProductURL data structure for the product webpage URL of the particular product image may be checked (e.g., may be looked up) to determine the Status thereof, as described above with reference to block 655 of FIG. 6B. In some embodiments, as described in more detail below with reference to FIG. 8, after the collage has been created (and thus, the corresponding first and second data structures have already been created), rather than determining any status updates from the ProductURL data structure through frequent lookups for each of the users and their corresponding first and second data structures, any updates to the status that may have been made in the ProductURL data structure may be automatically provided to the first and second data structures of all users associated with the product webpage URL having the update. Accordingly, latency of the ProductURL data structure from frequent lookups may be reduced, and processing resources may be reduced.

FIG. 8 illustrates a flow diagram of a method of identifying a change in status of a URL associated with a product image of at least one of a collection or a collage, according to one or more embodiments of the present disclosure. Compared to the method 600 described above with reference to FIGS. 6A and 6B corresponding to a time period relating to the generation of the collage, the method 800 described in more detail hereinafter may be performed at a time after the collage has already been generated based on the method 600 described above, for example, at a time when the status of the various product web page URLs in the ProductURL are periodically checked.

For example, the method 800 shown in FIG. 8 may be performed by the application/web server 106 (e.g., a processor thereof) described above. However, the present disclosure is not limited thereto, and the operations shown in the method 800 may be performed by any suitable one of the components and elements or any suitable combination of the components and elements of those of one or more example embodiments described above. Further, the present disclosure is not limited to the sequence or number of the operations of the method 800 shown in FIG. 8, and can be altered into any desired sequence or number of operations as recognized by a person having ordinary skill in the art. For example, in some embodiments, the order may vary, or the method 800 may include fewer or additional operations.

Referring to FIGS. 7 and 8, the method 800 may start at a time for updating the ProductURL data structure, and a URL entry may be identified in a fourth data structure (e.g., ProductURL) at block 805. For example, at block 805, the application/web server 106 (e.g., the processor thereof) may periodically identify a URL entry in the ProductURL data structure (e.g., a lookup table) that may be slated for updating. In some embodiments, for example, the application/web server 106 may determine from the corresponding UpdatedAt and UpdateCount fields for the URL entries in the ProductURL data structure whether or not the URL entries should be updated. For example, if the last update of a URL entry (e.g., as identified by the UpdatedAt field of the URL entry in the ProductURL data structure) exceeds a threshold time, and the count (e.g., as identified by the UpdateCount field of the URL entry in the ProductURL data structure) is less than a threshold count, the URL entry may be identified for updating.

A current status of the URL associated with the identified URL entry may be determined at block 810. For example, the application/web server 106 (e.g., the processor thereof) may connect to the URL to obtain the current status (e.g., active/inactive, price, stock availability, and/or the like) from the 3 ^{rd} party source, and may compare the obtained current status with the Status field of the URL entry in the ProductURL data structure to determine whether or not there were any changes made therein. As discussed above, the Status component of the ProductURL data structure may correspond to the validity/invalidity of the corresponding URL of the URL entry, and in some embodiments, may further include information pertaining to the stock, pricing, and/or availability of the product associated with the corresponding URL. If there is a change in the current status (e.g., YES at block 815), first and second data structures (e.g., SavedProduct and CollageProduct) of all users utilizing (e.g., in a collection and/or a collage) the product corresponding to the URL entry may be updated based on the change in the current status. If there is no change in the current status (e.g., No at block 815), the method 800 may end. In either case (e.g., Yes or No at block 815), the UpdatedAt and/or UpdateCount fields of the URL entry in the ProductURL data structure may be updated based on the check. Further, it should be appreciated to those having ordinary skill in the art that the method 800 may be repeated for other identified URL entries in the ProductURL data structure that may be slated for an update.

As such, the application/web server 106 (e.g., the processor thereof) may periodically obtain the status information for each URL entry in the ProductURL data structure for all relevant users at once, and may update the first and second data structures for all of the relevant users at the same or substantially the same time, rather than directly checking a particular product webpage URL for each user and each of the first and second data structures generated for each user. Accordingly, latency may be reduced, and processing resources may be reduced.

In some embodiments, the application/web server 106 (e.g., the processor thereof) may implement a batch-based processing mechanism to check the status of the URL entries in the ProductURL data structure. For example, batches of the URL entries in the ProductURL data structure may be identified for update, and subjected to the verification process described above to ascertain their validity, for example, by checking for HTTP status codes such as 404. If changes are detected, such as invalid link, being out of stock, or variations in price from the previously saved status information, the linked first and second data structures may be updated in real or near-real time. Subsequently, the user may be notified of these changes, ensuring that the user remains informed of the latest status of his/her saved product URLs.

For example, in some embodiments, the status updates may be provided to the user via a notification. For example, in some embodiments, the user may receive a Price Viewing notification, a Price Drop notification, and/or a Stock notification based on the Status components (and any updates thereto), and the notifications may be features that enhance the user's current platform experience. Price viewing notification may be a feature that allows the user to toggle on and off the ability to see product pricing information. Prices may be pulled via a unique code created to grab price information when the user is saving each product to their collection. Prices may be periodically scraped from the merchant's websites as described above. The system may then compare the saved product price and scraped product price. If there is a difference in product price, the system may notify the user(s) regarding the price drop. Stock notifications may notify the user when products they have saved in their collections and/or collages are running low on stock or are restocked. Stock notifications may be driven via merchant scraping and product feeds.

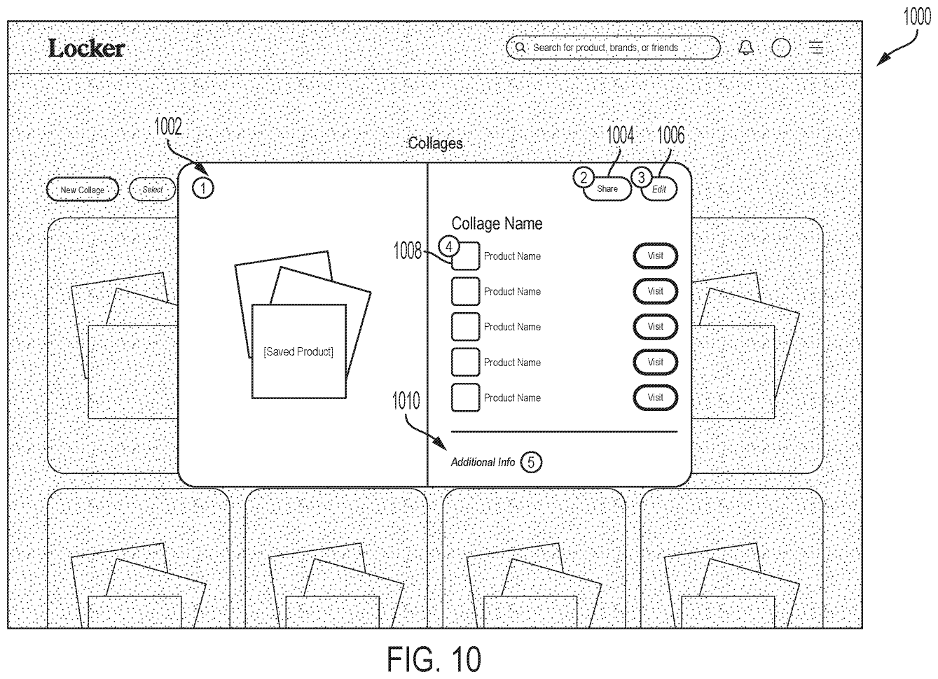

In some embodiments, as described further below with reference to FIG. 10, if the status of the URL entry in the ProductURL data structure becomes inactive, the system may employ a visual cue by “graying out” the product in the collection and/or collage, and disabling the ability to interact with the URL. On the other hand, if the product's URL remains active within the collage, the user retains the ability to interact with and access the associated URL link.

According to one or more embodiments of the present disclosure, unique brand offers may be provided to users through affiliate brand relationships. The system may receive a budget from a brand, which may be used to offer users unique discounts and/or codes to incentivize purchases. The brand budget may be allocated based on the system's first-party data (e.g., user data, activity data, collection data, and/or the like). The system's first-party data may give insights into consumer behavior and preferences based on specific brands, products, and product count saved in the user's collections. The system may then parse through all related users to determine which of the users may receive part of the brand budget allocation.

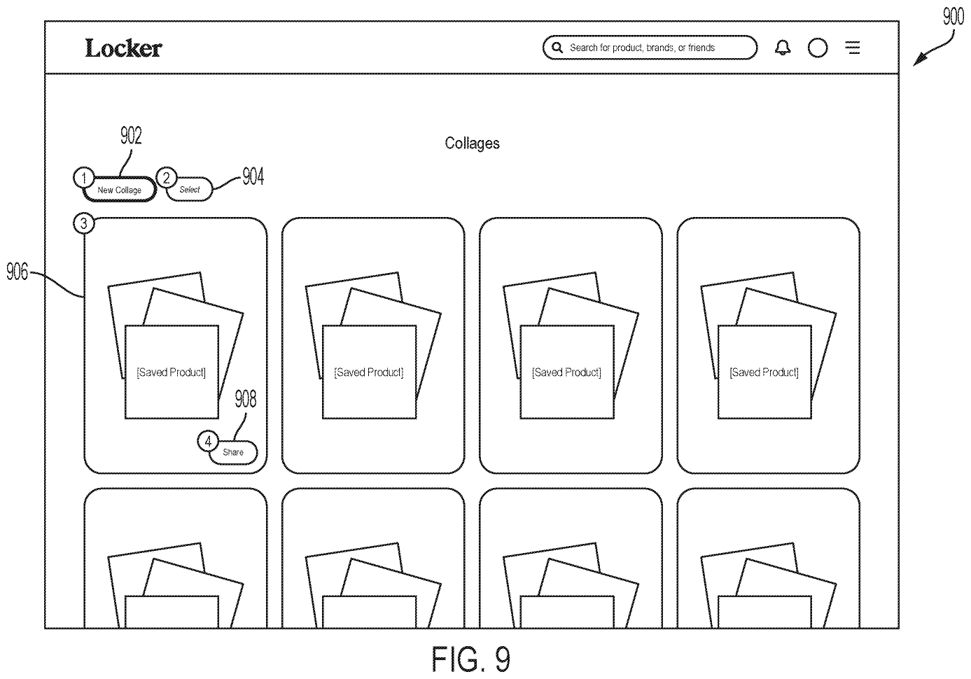

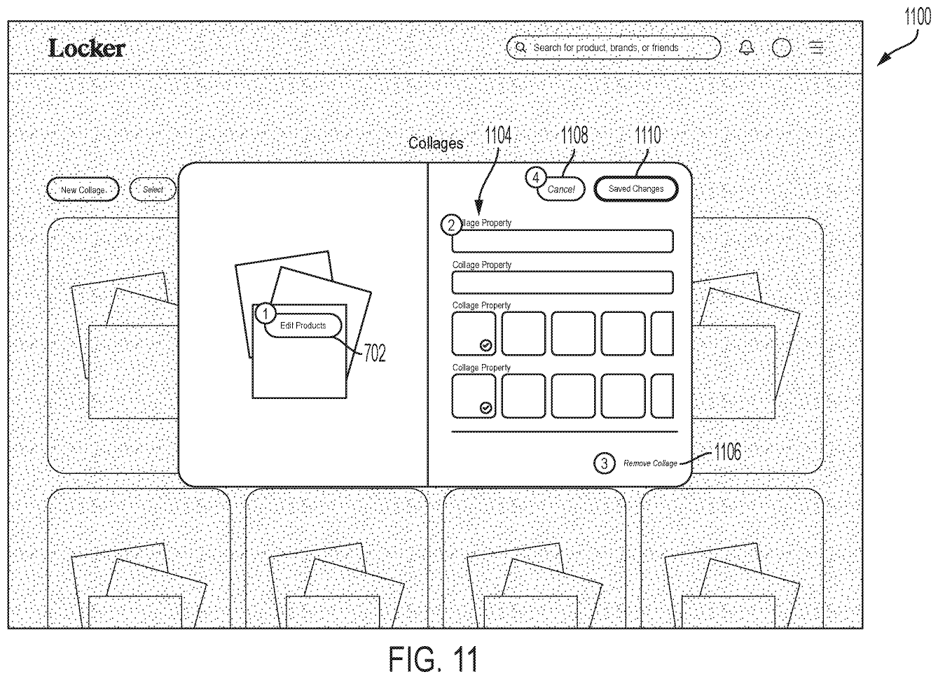

FIG. 9 is a schematic view of a collage view interface 900, according to one or more embodiments of the present disclosure. FIG. 10 is a schematic view of a selected collage interface 1000, according to one or more embodiments of the present disclosure. FIG. 11 is a schematic view of a quick edit interface 1100, according to one or more embodiments of the present disclosure.

According to one or more embodiments of the present disclosure, collages may be saved, viewed, and/or shared to other users. This allows the users to share their collages with friends and family, or with the wider community of users within the product page collection system 100. By providing users with the option to save their collages, the system ensures that users can revisit and edit their creations at a later time. This functionality adds a layer of convenience for users who may want to refine or update their collages over time. For example, according to one or more embodiments of the present disclosure, collages may be exported to “social media” sized graphics for easy sharing. This allows users to seamlessly integrate their collages into popular social media platforms, catering to the widespread practice of sharing personal creations with a broader audience.

Referring to FIG. 9, the collage view interface 900 may allow the user to quickly view the generated collages. For example, in some embodiments, when a user is logged-in to the product page collection system 100, and viewing their own collages, the user may be presented with the collage view interface 900. In some embodiments, the collage view interface 900 may include a new collage button 902, a select button 904, and one or more collage cards 906 corresponding to one or more generated collages.

According to one or more embodiments of the present disclosure, the new collage button 902 enables the user to quickly navigate to the collage creation interface 200, as shown in FIG. 2, to create a new collage as described above. The select button 904 allows the user to quickly navigate to a selection mode. In the selection mode, the user may be presented with an interface to select multiple collages, and may interact with the selected collages, such as deleting multiple collages and other accessory functions.

The collage cards 906 may represent the generated collages that are presented to the user in the form of cards. Through the collage cards 906, each collage may be clearly viewed as designed by the user, along with other pertinent information, such as the collage title. According to one or more embodiments of the present disclosure, each of the collage cards 906 may include a share button 908. When the user selects the share button 908 of a corresponding collage card 906, the user may be presented with multiple possible forms of sharing the corresponding collage, for example, such as via an email, a link, a social media platform, and/or the like. For example, in some embodiments, when a share button 908 of a corresponding collage card is selected, a URL that is unique to the corresponding collage may be generated (e.g., via the SharePath component of the Collage data structure described above) and provided to enable the sharing of the corresponding collage.

Referring to FIG. 10, in response to selecting a collage card 906 or in the selection mode, the user may be presented with the selected collage interface 1000. The selected collage interface 1000 may allow the user to view, share, edit, click the link to a product 1008 and/or the like in a selected collage. For example, according to one or more embodiments of the present disclosure, the selected collage interface 1000 may include a collage preview panel 1002, a share button 1004, an edit button 1006, collage products 1008, and an additional info area 1010.

The collage preview panel 1002 may be similar to the view of the selected collage card 906, in that it displays the user's collage as it was designed. The share button 1004, like the share button 908 described above, may present the user with multiple possible forms of sharing the corresponding collage, for example, such as via an email, a link, a social media platform, and/or the like. For example, according to one or more embodiments of the present disclosure, when the share button 1004 is selected, a URL that is unique to the corresponding collage may be generated and provided to enable the sharing of the corresponding collage.

The edit button 1006 may enable the user to quickly navigate to a quick edit mode. In the quick edit mode, the user may be presented with the quick edit interface 1100. The quick edit interface 1100 will be described in more detail below with reference to FIG. 11. The collage products 1008 may represent a list of the products included in the collage. For example, according to one or more embodiments of the present disclosure, the collage products 1008 may include a small preview (e.g., a thumbnail image of the product image), along with a visit button for visiting the URL of the product (e.g., the product page) of the merchant's website. However, if a particular product has an inactive status as discussed above, the small preview and/or the visit button for that product in the collage may be grayed out to provide a visual queue to the user that the product web page URL is no longer valid. The additional info area 1010 may display additional information associated with the collage that are shown alongside the collage products 1008, such as the creator of the collage, notes about the collage, and/or the like.

Referring to FIG. 11, according to one or more embodiments of the present disclosure, the user may be presented with the quick edit interface 1100. For example, as discussed above, in some embodiment, the user may be presented with the quit edit interface 1100 when the edit button 1006 is selected from the selected collage interface 1000. In some embodiments, the quick edit interface 1100 may include an edit products button 1102, a property panel 1104, a remove collage button 1106, a cancel button 1108, and a save button 1110.

The edit products button 1102 when selected may direct the user to the collage creation interface 200, as shown in FIG. 4, for full editing of the corresponding collage. The property panel 1104 may be a panel for adjusting all properties related to the collage. The property panel 1104 may allow the user to change the base properties on the collage, such as the title or background. The remove collage button 1106 may enable the user to remove the collage from the user's profile. According to one or more embodiments of the present disclosure, in the quick edit mode, when the user clicks the remove collage button 1106, the user may be prompted to confirm their selection to ensure they are certain of the changes. The cancel button 708 and the save changes button 1110 may be used to cancel all pending changes and to save any changes, respectively.

It will be understood that, although the terms “first,”“second,”“third,” etc., may be used herein to describe various elements, components, regions, layers and/or sections, these elements, components, regions, layers and/or sections should not be limited by these terms. These terms are used to distinguish one element, component, region, layer or section from another element, component, region, layer, or section. Thus, a first element, component, region, layer, or section described below could be termed a second element, component, region, layer, or section, without departing from the spirit and scope of the present disclosure.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,”“comprising,”“includes,”“including,”“has,”“have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

As used herein, the term “substantially,”“about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,”“using,” and “used” may be considered synonymous with the terms “utilize,”“utilizing,” and “utilized,” respectively.

The electronic or electric devices (e.g., device, processing circuit, server, and/or the like) and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A system comprising:
a processor; and
memory comprising instructions that, when executed by the processor, cause the processor to:
receive a selection of a product image stored in a collection of product images for inclusion in a collage;
identify a link to a product webpage associated with the product image;
generate code for the collage based on at least the product image and the link; and
transmit the code for the collage to be displayed on a display device of a user,
wherein the collage is configured to enable the user to navigate to the product webpage based on the link.

2. The system of claim 1, wherein the instructions further cause the processor to identify a first data structure for the product image stored in the collection, and
wherein the link is identified from the first data structure.

3. The system of claim 2, wherein the instructions further cause the processor to generate a second data structure for the product image in the collage based on at least the link identified from the first data structure, and
wherein the first and second data structures are independently maintained from each other.

4. The system of claim 3, wherein the instructions further cause the processor to generate a third data structure for the collage based on at least the second data structure, and
wherein the third data structure references the second data structure.

5. The system of claim 4, wherein the code is generated based on at least the second and third data structures.

6. The system of claim 3, wherein to generate the second data structure, the instructions further cause the processor to:
identify a status of the link to the product webpage associated with the product image; and
input the status into a status component of the second data structure.

7. The system of claim 6, wherein the status corresponds to at least one of a validity of the link, a price of a product corresponding to the product image from the product webpage, or an availability of the product from the product webpage.

8. The system of claim 1, wherein the instructions further cause the one or more processor to:
determine that the link is no longer valid; and
deactivate the link for the product image in the collage.

9. The system of claim 8, wherein to determine that the link is no longer valid, the instructions further cause the one or more processors to:
identify a link entry for the product webpage in a table;
determine that the link entry is slated for an update;
connect to the product webpage; and
determine that a current status of the product webpage is inactive.

10. The system of claim 1, wherein:
the product image stored in the collection of product images is maintained through a first data structure configured to store at least link information for the link to the product webpage associated with the product image;
in response to the product image being selected for inclusion in the collage, a second data structure is generated based on the first data structure; and
when the product image is removed from the collection of product images, the first data structure for the collection is deleted, and the second data structure is maintained for the collage.

11. A system comprising:
a processor; and
memory comprising instructions that, when executed by the processor, cause the processor to:
receive a selection of a product image in a collection of product images for inclusion in a collage;
identify a first data structure associated with the product image in the collection;
generate a second data structure for the product image based on the first data structure;
generate the collage based on at least the second data structure; and
cause a display of the collage on a display device of a user.

12. The system of claim 11, wherein to generate the second data structure, the instructions further cause the processor to:
identify a link to a product webpage associated with the selected product image from the first data structure;
identify a status of the link through a lookup of a table; and
input the status into a status component of the second data structure.

13. The system of claim 12, wherein the status corresponds to at least one of a validity of the link, a price of a product corresponding to the product image from the product webpage, or an availability of the product from the product webpage.

14. The system of claim 12, wherein the instructions further cause the processor to:
identify a change in the status of the link; and
update each of the first and second data structures based on the change in the status.

15. The system of claim 14, wherein to determine the change in the status of the link, the instructions further cause the processor to:
identify a previously stored status of the link in the table;
connect to the product webpage associated with the selected product image;
identify a current status from the product webpage; and
compare the current status with the previously stored status to determine the change in status.

16. A method comprising:
receiving, by a processor, a selection of a product image in a collection of product images for inclusion in a collage;
identifying, by the processor, a first data structure associated with the product image in the collection;
generating, by the processor, a second data structure for the product image based on the first data structure;
generating, by the processor, the collage based on at least the second data structure; and
causing, by the processor, a display of the collage on a display device of a user.

17. The method of claim 16, wherein to generate the second data structure, the method further comprises:
identifying, by the processor, a link to a product webpage associated with the selected product image from the first data structure;
identifying, by the processor, a status of the link through a lookup of a table; and
inputting, by the processor, the status into a status component of the second data structure.

18. The method of claim 17, wherein the status corresponds to at least one of a validity of the link, a price of a product corresponding to the product image from the product webpage, or an availability of the product from the product webpage.

19. The method of claim 17, further comprising:
identifying, by the processor, a change in the status of the link; and
updating, by the processor, each of the first and second data structures based on the change in the status.

20. The method of claim 19, wherein to determine the change in the status of the link, the method further comprises:
identifying, by the processor, a previously stored status of the link in the table;
connecting, by the processor, to the product webpage associated with the selected product image;
identifying, by the processor, a current status from the product webpage; and
comparing, by the processor, the current status with the previously stored status to determine the change in status.
